(19) United States
(12) Patent Application Publication
(10) Pub. No.: US 2023/0199171 A1
(43) Pub. Date: Jun. 22, 2023

(54) Search Memory Management For Video Coding

(71) Applicant: MediaTek Inc., Hsinchu City (TW)

(72) Inventors: Yu-Ling Hsiao, Hsinchu City (TW); Chun-Chia Chen, Hsinchu City (TW); Chih-Wei Hsu, Hsinchu City (TW); Tzu-Der Chuang, Hsinchu City (TW); Ching-Yeh Chen, Hsinchu City (TW); Yu-Wen Huang, Hsinchu City (TW)

(21) Appl. No.: 17/994,400

(22) Filed: Nov. 28, 2022

Related U.S. Application Data
(60) Provisional application No. 63/291,970, filed on Dec. 21, 2021.

(51) Int. Cl. H04N 19/105; H04N 19/137; H04N 19/176; H04N 19/172

(52) U.S. Cl. CPC H04N 19/105; H04N 19/137; H04N 19/176; H04N 19/172

(57) ABSTRACT

Various schemes for managing search memory are described, which are beneficial in achieving enhanced coding gain, low latency, and/or reduced hardware for a video encoder or decoder. In processing a current block of a current picture, an apparatus determines a quantity of a plurality of reference pictures of the current picture. The apparatus subsequently determines, for at least one of the reference pictures, a corresponding search range size based on the quantity. The apparatus then determines, based on the search range size and a location of the current block, a search range of the reference picture, based on which the apparatus encodes or decodes the current block.

### CROSS REFERENCE TO RELATED PATENT APPLICATION

The present disclosure is part of a non-provisional patent application claiming the priority benefit of U.S. Provisional Patent Application No. 63/291,970, filed on 21 Dec. 2021, the content of which being incorporated by reference in its entirety.

### TECHNICAL FIELD

The present disclosure is generally related to video coding and, more particularly, to methods and apparatus for enhancing coding efficiency of a video encoder or decoder by efficient search memory management.

### BACKGROUND

Unless otherwise indicated herein, approaches described in this section are not prior art to the claims listed below and are not admitted as prior art by inclusion in this section.

Video coding generally involves encoding a video (i.e., a source video) into a bitstream by an encoder, transmitting the bitstream to a decoder, and decoding the video from the bitstream by the decoder parsing and processing the bitstream to produce a reconstructed video. The video coder (i.e., the encoder and the decoder) may employ various coding modes or tools in encoding and decoding the video, with a purpose, among others, of achieving efficient video coding manifested in, for example, a high coding gain. Namely, the video coder aims to reduce a total size of the bitstream that needs to be transmitted from the encoder to the decoder while still providing the decoder enough information about the original video such that a reconstructed video that is satisfactorily faithful to the original video can be generated by the decoder.

Many of the coding tools are block-based coding tools, wherein a picture or a frame to be coded is divided into many non-overlapping rectangular regions, or “blocks”. The blocks constitute the basic elements processed by the coding tools, as often seen in intra-picture prediction and inter-picture prediction, the two main techniques used in video coding to achieve efficient video coding by removing spatial and temporal redundancy, respectively, in the source video. In general, the video redundancy is removed by searching for, and finding, among a plurality of already-coded blocks called “candidate reference blocks”, one or more reference blocks that best resemble a current block to be coded. A frame that contains a candidate reference block is a “candidate reference frame”. With a reference block found, the current block can be coded or otherwise represented using the reference block itself as well as the difference between the reference block and the current block, called “residual”, thereby removing the redundancy. Intra-picture prediction utilizes reference blocks found within the same frame of the current block for removing the redundancy, whereas inter-picture prediction utilizes reference blocks each found not within the same frame of the current block, but in another frame, often referred to as a “reference frame” or “reference picture”, of the source video.

Being a block-based processor, the video coder codes the blocks sequentially, usually in a pipeline fashion. That is, a video coder may be a coding pipeline having several stages, with each stage configured to perform a particular function to a block to be coded before passing the block to the next stage in the pipeline. A block may progress through the coding pipeline stage by stage until it is coded. A frame is coded after all blocks within the frames progress through the coding pipeline. Not all already-coded blocks may serve as candidate reference blocks for intra- or inter-picture prediction. Likewise, not all already-coded frames may serve as candidate reference frames. Typically, only certain blocks of a candidate reference frame may serve as candidate reference blocks. Candidate blocks are usually blocks that are spatially or temporally close to the current block being coded, as there is a higher chance for the video coder to find among these candidate blocks the block(s) best resembling the current block, as compared to blocks that are spatially or temporally far away from the current block. The candidate blocks may be loaded into a physical memory, often a static random-access memory (SRAM) such as a level-3 (L3) memory, which is accessed by the intra-picture prediction engine or the inter-picture prediction engine of the video encoder and/or decoder to perform intra-picture or inter-picture prediction for the current block. The physical memory is often referred to as the “search memory” of the video encoder or decoder.

The video coder may employ specific algorithms for managing the search memory. For example, the algorithms may determine which blocks are to be loaded into the search memory as candidate blocks for the intra-picture and inter-picture prediction engines to access. The algorithms may be coding-tool-specific and may be modified to adapt to various parallel processing schemes, such as wavefront parallel processing (WPP), that the video coder may employ. Algorithms for managing the search memory play an important role in the efficiency with which the video coder may code the video. The efficiency of the video coder may be manifested in figures of merit like coding gain (e.g., a bitrate gain such as a Bjontegaard Delta-Rate gain) or subjective/objective quality (e.g., peak signal-to-noise ratio) of the coded video.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to managing search memory for video coding. It is believed that with the various embodiments in the present disclosure, benefits including enhanced coding gain, improved coding latency, simplified search memory access, and/or reduced hardware overhead are achieved.

In one aspect, a method is presented for encoding or decoding a current block of a picture of a video using block-based inter-picture prediction based on a plurality of reference pictures that are associated with or corresponding to the current picture. The reference pictures are pictures in the same video as the current picture, based on which the method may efficiently remove temporal redundancy in the current picture. The method may involve determining a quantity of the reference pictures, i.e., a number representing how many reference pictures there are that correspond to the current picture. Each reference picture has a unique index, e.g., a picture order count (POC), that is used to identify the respective reference picture in the temporal sequence of the video. In some embodiments, the method may involve using one or more ordered lists to store the indices of the reference pictures, and the method may determine the quantity of the reference pictures by examining the list(s) of indices. The method may involve determining a corresponding search range size (SR size) for each reference picture, or at least one of the reference pictures, whereas the SR size is determined, at least partially, based on the quantity of the reference pictures. The method may also involve identifying a location of the current block. For instance, the method may identify a pixel coordinate of the first pixel of the current block (e.g., the pixel at the top-left corner, or the center, of the current block) as the location of the current block. Based on the location of the current block and the SR size, the method may involve determining, for each reference picture, or the at least one of the reference pictures, a search range (SR) encompassing a plurality of blocks of the reference picture that may be used as candidate reference blocks for coding the current block. The method may then involve coding the current block based on the candidate reference blocks within the SR of each of the plurality of reference pictures, or of the at least one of the reference pictures. In some embodiments, the method may involve determining the SR size based on a size of a search memory in addition to the quantity of the reference pictures, wherein the search memory is configured to store the candidate reference blocks from each of the reference pictures, or from the at least one of the reference pictures.

In some embodiments, the method may involve using two ordered lists, rather than one, for tracking the reference pictures. For example, in an event that the current picture is a so-called “bi-directional predicted frame”, or “B-frame”, as defined in contemporary video coding standards, inter-picture prediction may be performed using two ordered lists, one for each prediction direction. The two lists may or may not have repeated reference pictures. In an event that a same reference picture is repeated, i.e., appears in both lists, the reference picture is counted twice towards the quantity. For example, the two lists, referred to as “list 0” and “list 1”, may include a first number of indices and a second number of indices, respectively. Regardless of whether there is an index that appears in both the list 0 and the list 1, the quantity of the reference pictures is the sum of the first number and the second number. The method may involve designating a larger SR size for a reference picture that appears in both the list 0 and the list 1, and a smaller SR size for a reference picture that appears in only one of the two lists. That is, the method aims to allocate more of the search memory to a reference picture that appears in both lists, as the reference picture is utilized more (i.e., in prediction from both directions) than another reference picture that appears only in one of the two lists (i.e., used in prediction from one direction only).

In another aspect, an apparatus is presented which includes a reference picture buffer (RPB), one or more reference picture lists (RPLs), a search memory, a processor, and a coding module. The RPB is configured to store a plurality of reference pictures of a current picture, wherein each of the RPLs is configured to store one or more indices, and wherein each of the one or more indices corresponds to one of the reference pictures. In some embodiments, the POCs of the reference pictures may be used as the indices. The processor is configured to determine a quantity of the plurality of reference pictures based on the one or more RPLs. The processor may subsequently determine, based on the quantity and for each of the plurality of reference pictures, or for at least one of the reference pictures, a corresponding SR size. Moreover, the processor may identify a location of a current block of the current picture, such as the pixel coordinate of the pixel at the top-left corner or the center of the current block. Based on the location of the current block as well as the SR size corresponding to a reference picture, the processor may determine a search range (SR) encompassing a plurality of blocks of the respective reference picture as candidate reference blocks for coding the current block. The processor may determine candidate reference blocks in a same way for another one or more or each of the reference pictures of the current picture. The processor may also store the candidate reference blocks as determined to the search memory. The search memory may be accessed by the coding module so that the coding module may code the current block using the plurality of blocks of the reference pictures within the SRs of the reference pictures, i.e., the candidate reference blocks stored in the search memory.

In some embodiments, the apparatus may further include a motion estimation module. The motion estimation module is configured to determine, for each reference picture, or at least one of the reference pictures, a respective macro motion vector (MMV) representing a picture-level spatial displacement pointing from the current picture to the respective reference picture, or from the respective reference picture to the current picture. Namely, the MMV may be seen as a picture-level motion vector of the respective reference picture. The processor may determine the SR of the respective reference picture further based on the MMV. In some embodiments, the motion estimation module may be part of the coding module.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example design in accordance with an implementation of the present disclosure.

FIG. 2 is a diagram of an example design in accordance with an implementation of the present disclosure.

FIG. 3 is a diagram of an example design in accordance with an implementation of the present disclosure.

FIG. 4 is a diagram of an example design in accordance with an implementation of the present disclosure.

FIG. 5 is a diagram of an example design in accordance with an implementation of the present disclosure.

FIG. 6 is a diagram of an example design in accordance with an implementation of the present disclosure.

FIG. 7 is a diagram of an example video encoder in accordance with an implementation of the present disclosure.

FIG. 8 is a diagram of an example video decoder in accordance with an implementation of the present disclosure.

FIG. 9 is a diagram of an example apparatus in accordance with an implementation of the present disclosure.

FIG. 10 is a flowchart of an example process in accordance with an implementation of the present disclosure.

FIG. 11 is a diagram of an example electronic system in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Implementations in accordance with the present disclosure relate to various techniques, methods, schemes and/or solutions pertaining to realizing efficient search memory management for a video encoder or decoder. According to the present disclosure, a number of possible solutions may be implemented separately or jointly. That is, although these possible solutions may be described below separately, two or more of these possible solutions may be implemented in one combination or another.

As described elsewhere herein above, an important factor that affects the coding efficiency of a video coder is how the video coder manages the search memory that stores the candidate reference blocks of a current block being coded. To this end, the video coder may employ various search memory management schemes, which may or may not be specific to the coding tool(s) being used. For example, the video coder may employ an algorithm to determine which already-coded blocks may be used as candidate reference blocks for coding the current block.

Several search memory management schemes are described in detail below. Firstly, search memory management using an adaptive search range size is described, wherein different reference pictures may have different sizes of search range, within which the candidate reference blocks reside. Secondly, search memory management using an adaptive search range location is described, wherein the location of the search range of each reference picture may or may not have a corresponding shift with respect to the current block being coded. The adaptive search range location aims to increase the chance of finding a better reference block, e.g., having a lower residual. Thirdly, search memory management with coding tree unit (CTU) based parallel processing is described.

### I. Adaptive Search Range Size

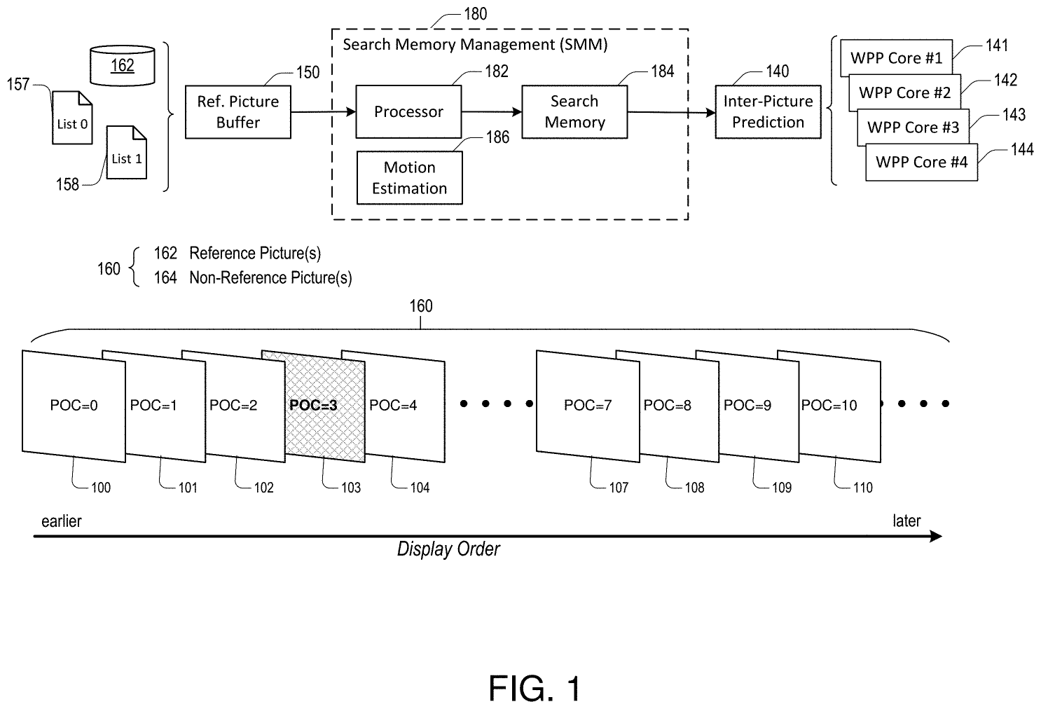

FIG. 1 is a diagram of an example design in accordance with an implementation of the present disclosure, wherein a search memory management module (SMM) 180 is employed to provide a search memory management scheme for coding a current block of a current picture of a video. The video includes multiple pictures, or “frames”, that are presented or otherwise displayed in a temporal sequence, such as a temporal sequence 160. As shown in FIG. 1, the temporal sequence 160 includes a series of pictures, such as a picture 100, a picture 101, a picture 102, a picture 103, a picture 104, . . . , a picture 107, a picture 108, a picture 109 and a picture 110, wherein a temporal relationship exists among the pictures. The temporal relationship is manifested in a sequential order of the pictures as the temporal sequence 160 is displayed as a video according to the sequential order. For example, the picture 100 is the first picture of temporal sequence 190. That is, the picture 100 represents the first frame as the temporal sequence 190 is presented (e.g., recorded or displayed) as the video. The picture 102 is displayed after the picture 101 in time, which is followed by the picture 103, which is followed by the picture 104, etc., in the temporal sequence 160. Similarly, the picture 107 is followed by the picture 108, which is followed by the picture 109, which is followed by the picture 110, and so on. Moreover, each of the pictures of the temporal sequence 160 has a temporal identifier, called “picture order count (POC)”, which is an integer index used to record or otherwise identify a temporal location of the respective picture in the temporal sequence 160. As shown in FIG. 1, the picture 100 has the respective temporal identifier specified or otherwise recorded as POC=0, whereas the POC of the picture 101 is specified as POC=1. Similarly, the POC values of the pictures 102, 103, 104, 107, 108, 109 and 110 are specified as POC=2, 3, 4, 7, 8, 9, and 10, respectively, as shown in FIG. 1. Using this scheme, the temporal relationship among the pictures as they are displayed as the video is recorded. The POC value of a particular picture identifies the temporal location of the picture in the temporal sequence of the video. Each picture in the temporal sequence has a unique POC value, and a first picture having a POC value smaller than that of a second picture must precede the second picture when the temporal sequence is displayed. The POC information is important for the SMM 180 to perform search memory management functions, as will be disclosed in detail elsewhere herein below.

The general idea of search memory management according to the present disclosure is as follows. In the present disclosure, the terms “frame”, “picture” and “picture frame” are interchangeably used to refer to a picture in a video, such as any of the pictures 100-110. An inter-picture prediction module 140 is configured to encode or decode a current picture of the temporal sequence 160 using a block-based approach. The inter-prediction module 140 may employ block-based motion estimation (ME) and motion compensation (MC) techniques commonly employed in interframe coding, especially the ones using block-matching algorithms. As described elsewhere herein above, in the block-based approach, each picture in the temporal sequence 160 is divided into a plurality of non-overlapping rectangular regions, referred to as “blocks”. The inter-picture prediction module 140 codes a current picture by processing the blocks of the current picture sequentially, until all blocks of the current picture are processed. A block of the current picture that is being processed by the inter-prediction module 140 is referred to as the “current block”. For example, the inter-prediction module 140 may be processing the picture 103. That is, the picture 103 is the current picture. The inter-prediction module 140 may encode or decode the current picture 103 by applying the ME and MC techniques to a plurality of reference pictures corresponding to the current picture 103, i.e., some of other frames in the temporal sequence 160. For example, the reference pictures corresponding to the current picture 103 may include the pictures 100, 102, 104 and 108.

Each picture of the temporal sequence 160 may have a corresponding group of reference pictures. In general, not each picture of the temporal sequence 160 is a reference picture for one or more other pictures of the temporal sequence 160. Namely, pictures of the temporal sequence 160 may be categorized into two groups, i.e., a first group 162 comprising reference pictures, and a second group 164 comprising non-reference pictures. Pictures belonging to the first group 162 may be stored in a reference picture buffer (RPB) 150 that is accessible to the SMM 180.

In addition to storing the reference pictures 162, the RPB 150 may also store one or more lists, called reference picture lists, or RPLs. Each of the RPLs includes one or more indices, wherein each of the one or more indices corresponds to a reference picture of the current picture. Based on the indices stored in the RPL(s), the SMM 180 is able to relay information of the reference pictures to the inter-prediction module 140. Specifically, the SMM 180 may include a processor 182 and a search memory 184. For at least one of the reference pictures (i.e., any or each of the pictures 100, 102, 104 and 108) of the current picture 103, the processor 182 may determine a corresponding search range (SR) that includes a portion of the respective reference picture. The processor 182 may further store, for the at least one of the reference pictures of the current picture 103, pixel data within the SR to the search memory 184. The inter-prediction module 140 may access the search memory 184 and encode or decode the current picture 103 based on the pixel data stored in the search memory 184.

In some embodiments, each RPL stored in the RPB 150 may be an ordered list. That is, the indices recorded in each RPL are recorded with an order, which may be an indication of a priority of the respective reference picture when the inter-prediction module 140 applies ME and MC techniques using pixel data of the reference pictures of the current picture. In some embodiments, the indices may be the POCs of the reference pictures 162. The number of RPLs associated with the current picture 103 depends on the picture type of the current picture 103. The picture type may indicate that the current picture 103 is either a predicted frame (P-frame) or a bi-directional predicted frame (B-frame) as defined in contemporary video coding standards such as Versatile Video Coding (VVC), High Efficiency Video Coding (HEVC), or Advanced Video Coding (AVC). In an event that the current picture 103 is a P-frame, the RPB 150 may store only one RPL, such as a RPL 157. In an event that the current picture 103 is a B-frame, the RPB 150 may store two RPLs, such as the RPL 157 and another RPL 158. The one RPL corresponding to a P-frame is often referred to as “list 0”, whereas the two RPLs corresponding to a B-frame are often referred to as “list 0” and “list 1”, respectively.

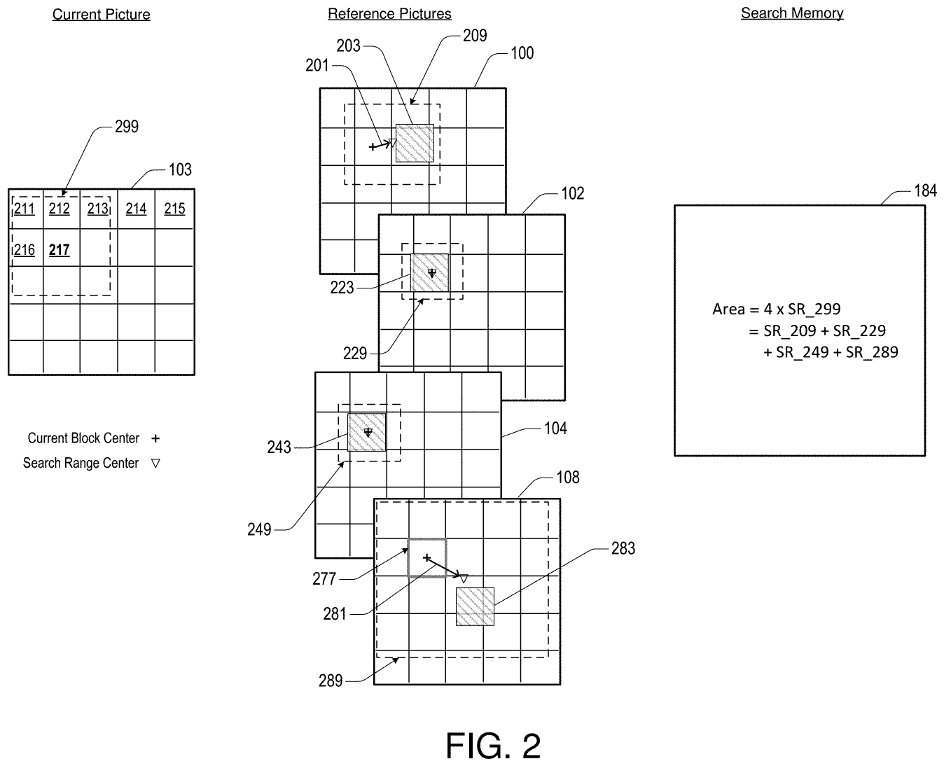

FIG. 2 is a diagram of an example design in accordance with an implementation of the present disclosure, wherein the current picture 103 may be divided into a plurality of non-overlapping rectangular blocks, such as blocks 211, 212, 213, 214, 215, 216 and 217. The inter-prediction module 140 may process the blocks of the current picture 103 sequentially. Specifically, for each block of the current picture 103, the inter-prediction module 140 is configured to find a best-matching block in each of the reference pictures 100, 102, 104 and 108, wherein the best-matching block is a block that resembles, and has a same size as, the respective block of the current picture 103. The boundaries of the best-matching block may or may not be aligned with the boundaries of the non-overlapping rectangular blocks of the current picture 103. The inter-prediction module 140 may find the best-matching block by searching a respective search range (SR) in at least one and at most every one of the reference pictures using an integer pixel search algorithm. In some embodiments, the inter-prediction module 140 may find the best-matching block using a fractional pixel search algorithm following the integer pixel search algorithm.

Referring to FIG. 2, the prediction module 140 may be currently processing the block 217 of the picture 103; i.e., the picture 103 is the current picture, whereas the block 217 is the current block. The RPL(s) corresponding to the current picture 103 have POCs 0, 2, 4 and 8 recorded thereon. Namely, the reference pictures corresponding to the current picture 103 are pictures 100, 102, 104 and 108. Accordingly, the inter-prediction module 140 may find a best-matching block 203 from the picture 100 by searching a SR 209 within the picture 100. Similarly, the inter-prediction module 140 may find a best-matching block 223 from the picture 102 by searching a SR 229 within the picture 102. Likewise, the inter-prediction module 140 may find best-matching blocks 243 and 283 from the pictures 104 and 108, respectively, by searching a SR 249 and a SR 289 within the pictures 104 and 108, respectively.

As described above, the processor 182 determines the search ranges 209, 229, 249 and 289 for reference pictures 100, 102, 104 and 108, respectively. In general, a search range has a rectangular shape. Each of the search ranges 209, 229, 249 and 289 is defined by a size and a location thereof. The size of a search range, or the “SR size”, may be represented by the height and the width of the search range, or by a total area of the search range. The location of a search range may be identified using a pixel coordinate of the search range within the reference picture. For example, the coordinate of the top-left pixel of the search range may be used to identify the location of the search range. As another example, the pixel coordinate of the center of the search range may be used to identify the location of the search range.

In some embodiments, every search range is centered around the current block. Therefore, a coordinate that identifies the current block may be sufficient to identify the location of each search range. For example, in some embodiments, each of the SRs 209, 229, 249 and 289 may be centered around the current block 217. Therefore, a pixel coordinate identifying the location of the current block 217 (e.g., the coordinate of the top-left pixel of the current block 217) may be used to identify the location of each of the SRs 209, 229, 249 and 289.

In some embodiments, all search ranges may not be centered around the current block. That is, there may exist a displacement between the center of the current block and the center of a search range. For example, the SR 209 and the SR 289 may not be centered around the current block 217, and a displacement may be used to identify the relative shift of the location of the SR 209 or 289 as compared to the location of the current block 217. The displacement may be a vector pointing from the center of the current block 217 to the center of the SR 209 or 289. Alternatively, the displacement may be a vector pointing from the center of the SR 209 or 289 to the center of the current block 217.

In some embodiments, all SRs may have a same SR size, and the SR size is equal to a default size. In some embodiments, the default size may be a multiple of the size of the current block. For example, each of the SRs 209, 229, 249 and 289 may have a width that is x times the width of the current block 217, as well as a height that is y times the width of the current block 217. In some embodiments, x may be equal to y, such as x=y=2.5 or x=y=5. In some embodiments, x may not be equal to y, such as x=5 and y=2.5.

In some embodiments, all SRs may have a same SR size, and the processor 182 may determine the SR size based on a quantity of the reference pictures of the current picture. Moreover, the processor 182 may determine the SR size such that a total size of all the SRs remain a constant value regardless the quantity of the reference pictures. The processor 182 may find or otherwise determine the quantity of the reference pictures of the current picture by accessing the RPB 150. Specifically, the processor 182 may determine the quantity by examining the one or more RPLs stored in the RPB 150 (e.g., the RPLs 157 and 158), as each RPL contains the POC values of the reference pictures. For example, the processor 182 may examine the RPLs 157 and 158, thereby determining that picture 103 has four reference pictures (i.e., the pictures 100, 102, 104 and 108). Likewise, the processor 182 may examine the RPLs 157 and 158 and determine that the picture 108 has only two reference pictures (e.g., the pictures 107 and 109). Since the quantity of the reference pictures of the current picture 103 is twice as that of the current picture 108, the processor 182 may determine that the SR size of the reference pictures of the current picture 103 is half of that of the current picture 108, such that the total size of the SRs of the current picture 103 is the same as that of the current picture 108. Namely, the SR size is the constant value divided by the quantity of the reference pictures of the current picture. In some embodiments, the constant value of the total size of the SRs may be substantially equal to the size of the search memory 184, wherein the size of the search memory 184 is proportional to the total capacity of the search memory 184 and may be measured in the amount of pixel data the search memory 184 is capable of storing. In an event that the video coder is realized using physical electronic components such as those in a semiconductor integrated circuit (IC) chip, the search memory 184 may be realized using a static random-access memory (SRAM), such as a level-3 (L3) memory, which is a component of the IC chip. Thus, the capacity of the search memory 184 is a fixed value depending on the size of the SRAM included on the IC chip. The processor 182 may thus determine the SR size for each reference picture by dividing the size of the search memory 184 by the quantity of the reference pictures of the current picture.

In some embodiments, each reference picture may or may not have a respectively different size of the SR. To determine the respective SR size for each of the reference pictures, the processor 182 may first determine a basic SR size, or “basic size”. The processor 182 may then determine the respective SR size based on the basic size and the picture type of the current picture. For example, if the current picture is a P-frame, each of the reference pictures may have a SR that has a same SR size. Specifically, the processor 182 may designate the basic size as the SR size for each of the reference pictures. If the current picture is a B-frame, there may be scenarios wherein a reference picture has a larger or smaller SR size than another reference picture. The determination of the basic size and its relationship with the SR size(s) for different types of the current picture are described next.

In an event that the current picture is a P-frame, there is only one corresponding RPL (e.g., the RPL 157 or 158) stored in the RPB 150. The processor 182 may determine the quantity of the reference pictures of the current picture by examining the RPL stored in the RPB 150. The processor 182 may then determine a basic size of the SR of the reference picture(s) of the current picture based on the quantity. For example, the picture 108 may be a P-frame having two reference pictures: the POC=0 picture (i.e., the picture 100) and a POC=16 picture (not shown in FIG. 1). Therefore, when the picture 108 is the current picture, the POC=0 picture and the POC=16 picture are stored as part of the reference pictures 162. Also, the RPB 150 may include RPL 157, which includes POC values 0 and 16 as indices identifying the POC=0 picture and the POC=16 picture as the reference pictures of the current picture 108. The processor 182 may examine the RPL 157 and accordingly determine that the quantity of the reference pictures of the current picture 108 is two, because the RPL 157 includes two indices. The processor 182 may then determine the basic size of the SR to be a default size divided by the quantity (i.e., two). Alternatively, the processor 182 may determine the basic size of the SR to be the size of the search memory 184 divided by the quantity (i.e., two). After the basic size is determined, the processor 182 may designate the basic size as the SR size for each of the reference pictures of the current picture 108, i.e., for the POC=0 picture and the POC=16 picture.

In an event that the current picture is a B-frame, there are two corresponding RPLs (e.g., the RPLs 157 and 158) stored in the RPB 150. The processor 182 may determine the quantity of the reference pictures of the current picture by examining the RPLs stored in the RPB 150. The two RPLs may include a first number of indices and a second number of indices, respectively. It is to be noted that a same index may appear in both of the two RPLs. Namely, there may be an index that is repeated in both RPLs. The processor 182 may determine the quantity as a sum of the first number and the second number regardless of any repeated index, or a lack thereof. The processor 182 may then determine a basic size of the SR of the reference picture(s) of the current picture based on the quantity. For example, the picture 108 may be a B-frame having two reference picture indices recorded in each of the RPLs 157 and 158. Specifically, the RPL 157 may include two indices 0 and 16, which identify the POC=0 picture (i.e., the picture 100) and a POC=16 picture (not shown in FIG. 1) as reference pictures of the picture 108, whereas the RPL 158 may include two indices 16 and 32, which identify the POC=16 picture and a POC=32 picture (not shown in FIG. 1) as reference pictures of the picture 108. Therefore, when the picture 108 is the current picture, the POC=0 picture, the POC=16 picture and the POC=32 picture are stored as part of the reference pictures 162. Note that the POC=16 picture appears in both the RPL 157 and the RPL 158. The processor 182 may examine the RPLs 157 and 158 and calculate a sum of the first number (i.e., two) and the second number (i.e., two). The processor 182 may accordingly determine the quantity of the reference pictures of the current picture 108 by designating the sum of the first number and the second number (i.e., four) as the quantity. It is worth noting that the quantity is determined to be four, even though for the current picture 108 there are only three distinctive reference pictures (i.e., the POC=0 picture, the POC=16 picture, and the POC=32 picture). This is because the POC=16 picture appears in both the RPL 157 and the RPL 158, and is thus counted twice towards the quantity. The processor 182 may then determine the basic size of the SR to be a default size divided by the quantity (i.e., four). Alternatively, the processor 182 may determine the basic size of the SR to be the size of the search memory 184 divided by the quantity (i.e., four). After the basic size is determined, the processor 182 may determine the SR size for each of the reference pictures of the current picture 108 based on whether the respective reference picture is in one or both of the RPLs 157 and 158. For reference picture(s) appearing in only one of the RPLs 157 and 158, i.e., the POC=0 picture and the POC=32 picture, the processor 182 may designate the basic size as the SR size. For reference picture(s) appearing in both the RPLs 157 and 158, i.e., the POC=16 picture, the processor 182 may designate twice the basic size as the SR size. Namely, the SR of the POC=16 picture has a size that is a double of the size of the SR of the POC=0 or 32 picture. The double of the SR size may be manifested in a larger width of the SR, a larger height of the SR, or both a larger width and a larger height of the SR.

In the embodiment for coding a B-frame current picture as described above, the processor 182 aims at allocating a larger portion of the search memory 184 to a reference picture that appears in both list 0 (i.e., the RPL 157) and list 1 (i.e., the RPL 158) as compared to another reference picture that appears in only list 0 or list 1. A larger SR increases the possibility of finding a better reference block. That is, a reference block found by the inter-prediction module 140 within a larger SR is expected to have a smaller MC residual as compared to a reference block found within a smaller SR. The processor 182 is configured to allocate a larger portion of the search memory 184 to a reference picture that appears in both list 0 and list 1 because a better reference block for the reference picture benefits the inter-picture prediction in both directions of coding the B-frame current picture. In contrast, the processor 182 is refrained from allocating a larger portion of the search memory 184 to a reference picture that appears in only list 0 or list 1 because a better reference block for the reference picture would benefit the inter-picture prediction in only one direction of coding the B-frame current picture.

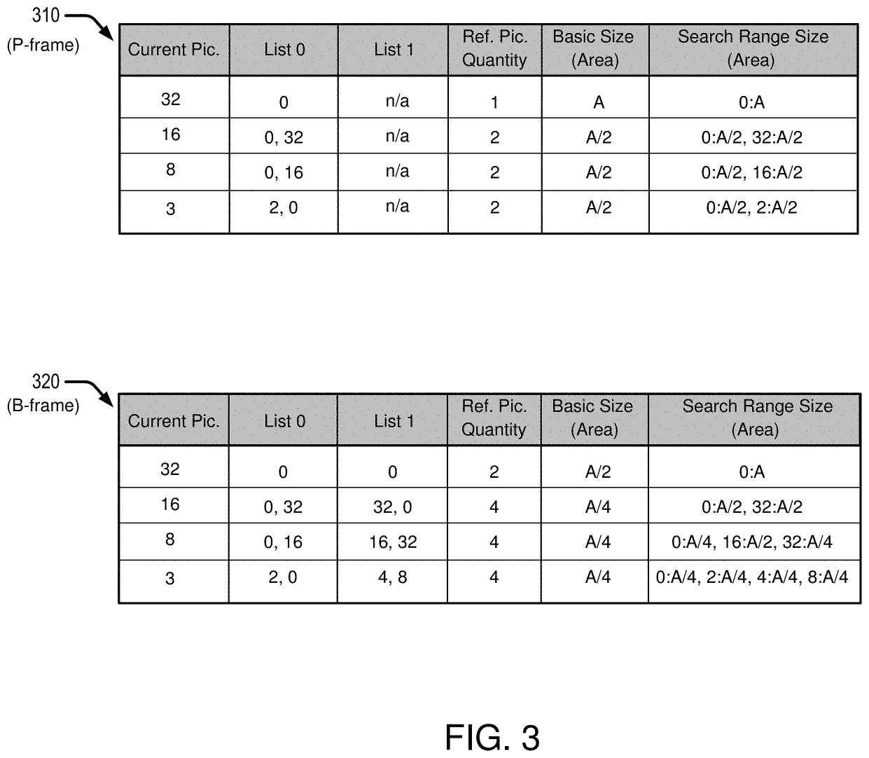

FIG. 3 is a diagram of an example design in accordance with an implementation of the present disclosure, wherein a table 310 and a table 320 are shown for coding example P-frames and B-frames, respectively, using the search memory management schemes described above. As shown in the table 310, in an event that the current picture (i.e., the picture having POC=32, 16, 8 or 3) is a P-frame, the index or indices (i.e., the POC value(s)) of the corresponding reference picture(s) are stored in the List 0 (i.e., the RPL 157), whereas the List 1 (i.e., the RPL 158) is empty. The processor 182 may examine the List 0 and determine the quantity of the reference pictures as 1, 2, 2 and 2 for the current picture having POC=32, 16, 8 and 3, respectively. The processor 182 may further determine, based on the quantity of the reference pictures, the basic SR size to be A, A/2, A/2 and A/2, respectively, wherein A may be a default value, or alternatively, the size of the search memory 184. The processor 182 may then designate the basic SR size as the SR size of each reference picture. For example, for the POC=32 current picture, the SR size for the POC=0 reference picture is A. For the POC=16 current picture, the SR size for each of the POC=0 reference picture and the POC=32 reference picture is A/2. For the POC=8 current picture, the SR size for each of the POC=0 reference picture and the POC=16 reference picture is A/2. For the POC=3 current picture, the SR size for each of the POC=2 reference picture and the POC=0 reference picture is A/2.

Likewise, as shown in the table 320, in an event that the current picture (i.e., the picture having POC=32, 16, 8 or 3) is a B-frame, the index or indices (i.e., the POC value(s)) of the corresponding reference picture(s) are stored in at least one of the List 0 (i.e., the RPL 157) and the List 1 (i.e., the RPL 158). The processor 182 may examine both the List 0 and List 1, and thereby determine the quantity of the reference pictures as 2, 4, 4 and 4 for the current picture having POC=32, 16, 8 and 3, respectively. The processor 182 may further determine, based on the quantity of the reference pictures, the basic SR size to be A/2, A/4, A/4 and A/4, respectively, wherein A may be a default value, or alternatively, the size of the search memory 184. The processor 182 may then designate the basic SR size as the SR size of each reference picture that appears in only one of the List 0 and the List 1, and twice the basic SR size as the SR size for each reference picture that appears in both the List 0 and the List 1. For example, for the POC=32 current picture, the SR size for the POC=0 reference picture is twice the basic SR size, and thus, A. For the POC=16 current picture, the SR size for each of the POC=0 reference picture and the POC=32 reference picture is twice the basic SR size, and thus, A/2. For the POC=8 current picture, the SR size for each of the POC=0 reference picture and the POC=32 reference picture is the basic SR size, and thus, A/4. However, the SR size for the POC=16 reference picture is twice the basic SR size, and thus, A/2. For the POC=3 current picture, the SR size for each of the POC=2 reference picture, the POC=2 reference picture, the POC=4 reference picture, and the POC=8 reference picture is the basic SR size, and thus, A/4.

It is to be noted that, in each row of the table 310 and table 320, the total collective area of the SR(s) of the reference picture(s) is equal to A, which may be a default value, or the size of the search memory 184.

In some embodiments, after the processor 182 determines the basic size as described above, the processor 182 may subsequently allocate a larger portion of the search memory 184 for a reference picture that is temporally farther away from the current picture as compared to a reference picture that is temporally closer to the current picture. For example, as shown in FIG. 2, the current picture is the picture 103, whereas the reference pictures are the pictures 100, 102, 104 and 108. The basic size as determined by the processor 182 is represented by the box labeled with numeral 299, which has a size equal to the size of the search memory 184 divided by the quantity of the reference pictures (i.e., four). The processor 182 may determine a temporal distance with respect to the current picture 103 for each of the reference pictures 100, 102, 104 and 108. The temporal distance may be determined by the processor 182 calculating an absolute value of a difference between the POC of the respective reference picture and the POC of the current picture. Accordingly, the processor 182 may calculate that the temporal distance of the reference picture 101 with respect to the current picture 103 is 2 counts, whereas the temporal distance of each of the reference pictures 102 and 104 with respect to the current picture 103 is 1 count. Likewise, the temporal distance of the reference picture 108 with respect to the current picture 103 is 5 counts. The processor 182 may subsequently determine the SR size of each of the reference pictures 100, 102, 104 and 108 based on the basic size and also on the respective temporal distance. That is, the processor 182 may designate a larger SR size to a reference picture having a larger temporal distance with respect to the current picture. Accordingly, the size of the SR 289 is larger than the size of the SR 209, which is larger than the size of the SR 249, which is equal to the size of the SR 229. In particular, the size of the SR 289 is larger than the basic size 299, whereas the size of the SR 229 and the SR 249 is smaller than the basic size 299.

In some embodiments, after the processor 182 determines the basic size as described above, the processor 182 may subsequently allocate a larger portion of the search memory 184 for a reference picture that is spatially farther away from the current picture (i.e., a high-motion reference picture) as compared to a reference picture that is spatially closer to the current picture (i.e., a low-motion reference picture). For example, as shown in FIG. 2, the current picture is the picture 103, whereas the reference pictures are the pictures 100, 102, 104 and 108. The basic size as determined by the processor 182 is represented by the box labeled with numeral 299, which has a size equal to the size of the search memory 184 divided by the quantity of the reference pictures (i.e., four). A motion estimation (ME) module 186 of the SMM 180 may determine a macro motion vector (MMV) with respect to the current picture 103 for each of the reference pictures 100, 102, 104 and 108. The MMV represents a spatial displacement from the current picture to the respective reference picture. The MMV may be determined by the ME module 186 performing a frame-based rate-distortion optimization operation using the current picture 103 and the respective reference picture 100, 102, 104 or 108. A reference picture having an MMV of a larger magnitude is spatially farther away from the current picture, whereas a reference picture having an MMV of a smaller magnitude is spatially closer to the current picture. The MMV may be determined by performing picture-level motion estimation between the respective reference picture and the current picture 103. Alternatively, the MMV may be determined by performing motion estimation based not on the whole frame, but on one or more blocks of the current picture and one or more corresponding blocks of the respective reference picture. The one or more blocks of the current picture may include the current block as well as some neighboring blocks of the current block. For example, with the block 217 being a current block, the one or more blocks of the current picture used for determining the MMV may include the current block 217 and a few neighboring blocks of the current block 217, e.g., the blocks 211, 212, 213 and 216. Based on the magnitude of the corresponding MMV, it may be determined that each of the reference pictures 102 and 104 is a low-motion reference picture because of a small magnitude of the corresponding MMV, whereas the reference picture 108 is a high-motion reference picture because of a larger magnitude of the corresponding MMV. The processor 182 may subsequently determine the SR sizes of the reference pictures 100, 102, 104 and 108 based on the magnitude of the respective MMV. That is, the processor 182 may designate a larger SR size to a reference picture having a larger magnitude of the respective MMV. Accordingly, the processor 182 may determine the size of the SR 289 to be larger than the size of the SR 249, which is equal to the size of the SR 229. In particular, the size of the SR 289 is larger than the basic size 299, whereas the size of the SR 229 and the SR 249 is smaller than the basic size 299.

In some embodiments, after the processor 182 determines the basic size as described above, the processor 182 may subsequently allocate a larger portion of the search memory 184 for a reference picture that does not have a theme change as compared to a reference picture that has a theme change. For example, the current picture is the picture 103, whereas the reference pictures are the pictures 100, 102, 104 and 108. The basic size as determined by the processor 182 is represented by the box labeled with numeral 299, which has a size equal to the size of the search memory 184 divided by the quantity of the reference pictures (i.e., four). The ME module 186 of the SMM 180 may determine whether the respective reference picture has a theme change from the current picture 103. For instance, the motion estimation module of the SMM 180 may determine that the respective reference picture has a theme change from the current picture 103 in an event that the motion compensation residual resulted from motion compensation between the respective reference picture and the current picture 103 is greater than a predefined threshold value. Accordingly, the motion estimation module of the SMM 180 may determine that each of the reference pictures 100, 102 and 104 has no theme change from the current picture 103, whereas the reference picture 108 has a theme change from the current picture 103. The processor 182 may subsequently determine the SR sizes of the reference pictures 100, 102, 104 and 108 based on whether there is a theme change between each of the reference pictures 100, 102, 104 and 108 and the current picture 103. The processor 182 may designate a smaller SR size to a reference picture having a theme change from the current picture 103. Accordingly, the size of each of the SRs 209, 229 and 249 is larger than the size of the SR 289. In particular, the size of the SR 289 is smaller than the basic size 299, whereas each of the SRs 209, 229 and 249 is larger than the basic size 299. In some embodiments, the processor 182 may designate a SR size of zero for a reference picture having a theme change from the current picture 103. That is, the size of the SR 289 may be zero.

### II. Adaptive Search Range Location

In order to determine or otherwise define a search range, it is necessary to determine both the size of the search range as well as the location of the search range. For example, in coding the current block 217 of the current picture 103, the SMM 180 is required to determine the size of each of the SRs 209, 229, 249 and 289, as well as the location of each of the SRs 209, 229, 249 and 289 within the reference pictures 100, 102, 104 and 108, respectively. The previous section is focused on disclosing how the SMM 180 may determine a size of a search range, whereas this section is focused on disclosing how the SMM 180 may determine a location of a search range.

In general, the location of a SR within a reference picture is related to the location of the current block within the current picture. In some embodiments, every search range is centered around the current block. Namely, the center of an SR is at the same location within the frame as the center of the current block. It follows that the location of each search range may be determined by referencing a pixel coordinate that identifies the location of the current block. For example, in some embodiments, each of the SRs 209, 229, 249 and 289 may be centered around the current block 217. Therefore, the location of each of the SRs 209, 229, 249 and 289 (e.g., a pixel coordinate that identifies a center pixel of the respective SR) may be determined by referencing a pixel coordinate identifying the location of the current block 217 (e.g., the coordinate of a center pixel of the current block 217).

In some embodiments, all search ranges may not be centered around the current block. That is, there may exist a displacement, or “shift”, between the center of the current block (labeled with symbol “+” in FIG. 2) and the center of a search range (labeled with symbol “∇” in FIG. 2). For example, the SR 209 and the SR 289 may not be centered around the current block 217, and a displacement may be used to identify the relative shift of the location of the SR 209 or 289 as compared to the location of the current block 217. The displacement may be expressed with a vector pointing from the center of the current block 217 to the center of the SR 209 or 289, such as a vector 201 or a vector 281. Alternatively, the displacement may be a vector pointing from the center of the SR 209 or 289 to the center of the current block 217.

The displacement as shown in FIG. 2 (e.g., the vector 201 or 281) is block-based and may be determined by the ME module 186 performing a block-based estimation. For instance, in determining the vector 281, the ME module 186 may perform block-based low-complexity rate-distortion optimization (LC-RDO) using pixel data within the current block 217 and pixel data of the same area as the current block 217 but from the reference picture 108 (i.e., pixel data within a block 277 of the reference picture 108).

In some embodiments, the displacement, or “shift”, may not be block-based, but rather, frame-based. That is, regardless which block of the current picture is the current block, the corresponding SR has a same shift. For example, when the block 217 is the current block being processed by the inter-prediction module 140, the corresponding SR 289 has a displacement represented by the vector 281. Likewise, when any of the other blocks of the picture 103 is the current block, the corresponding SR in the reference picture 108 has a shift, represented by a vector, from the current block, wherein the vector has the same direction and same magnitude as the vector 281. In some embodiments where the SR shift is frame-based, the ME module 186 may determine the MMV of the current picture as described elsewhere herein above. Moreover, the ME module 186 may apply the MMV as the SR shift for every block of the current picture.

In some embodiments, the current picture may be divided into several partitions, and the SMM 180 may designate a same SR shift to every block of a partition. For example, the partition may be a coding unit (CU) or a coding tree unit (CTU) as defined in contemporary video coding standards such as VVC, HEVC, or AVC. In some other embodiments, the partition may be a picture slice containing a plurality of spatially adjacent CTUs. In some embodiments, the partition may be a CTU row containing a plurality of CTUs concatenated in a row.

In some embodiments, the SMM 180 may designate a same SR shift to every reference picture in an RPL. That is, every reference picture whose index (e.g., POC) is in the List 0 (i.e., the RPL 157) has a same SR shift. Likewise, every reference picture whose index is in the List 1 (i.e., the RPL 158) has a same SR shift. The SR shift for the reference pictures in the List 0 may be same or different from the SR shift for the reference pictures in the List 1.

### III. Parallel Processing

To enhance coding speed or throughout, a video coder may employ various parallel processing schemes. For instance, the inter-prediction module 140 may contain two or more substantially identical processing units, often referred as “processing cores” or simply “cores”, to process blocks of a current picture. Accordingly, the SMM 180 is required to provide concurrent support to the two or more cores for the parallel processing schemes.

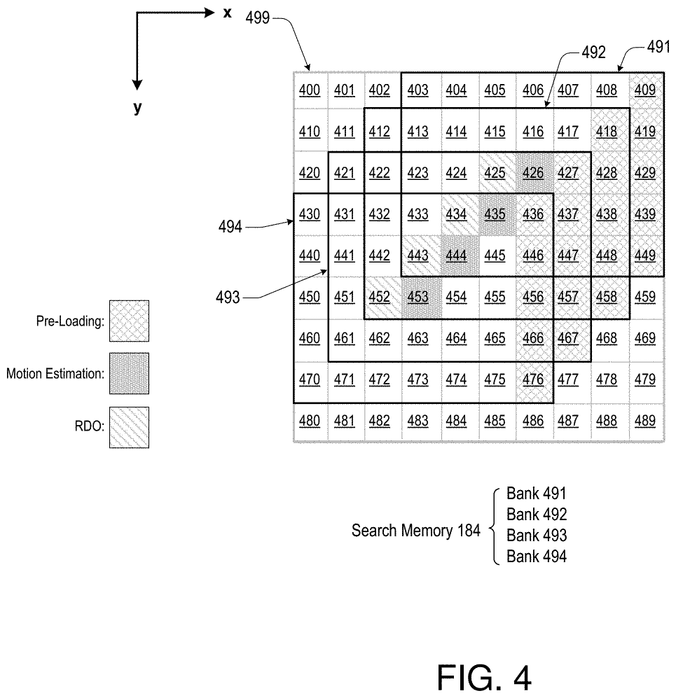

FIG. 4 is a diagram of an example design in accordance with an implementation of the present disclosure, wherein a current picture 499 is processed by the inter-prediction module 140 that includes four parallel processing cores. Accordingly, the SMM 180 may be required to have four SRAM banks 491, 492, 493 and 494, each of which is configured to support one of the four processing cores. As shown in FIG. 4, the current picture 499 includes a plurality of blocks, such as blocks 400-489. In particular, the blocks 400-489 form a 10×9 array, with each row of the array having 10 blocks and each column of the array having 9 blocks. In some embodiments, each block of the current picture 499 may be a CTU, and thus the current picture 400 includes nine CTU rows each having ten CTUs. The inter-prediction module 140 may process the current picture 499 using wavefront parallel processing (WPP). Specifically, the inter-prediction module 140 may include four WPP cores 141, 142, 143 and 144 that are configured to process four CTU rows of the current picture 499 concurrently. For example, the WPP core 141 may be processing the CTU row comprising the blocks 420-429, while the WPP core 142, 143 and 144 are processing the CTU rows of blocks 430-439, 440-449, and 450-459, respectively. Each of the WPP cores 141, 142, 143 and 144 is configured to process the CTUs of the respective CTU row sequentially along the x-direction as shown in FIG. 4.

The WPP cores 141-144 may process the CTUs in a pipeline fashion. Specifically, each of the WPP cores 141-144 may process a CTU in three pipeline stages: a pre-loading stage, a motion estimation (ME) stage, and a rate-distortion optimization (RDO) stage. Take the WPP core 141 for example. At a pipeline cycle depicted in FIG. 4, the WPP core 141 is performing ME for the block 426 and RDO for the block 425. At a next pipeline cycle, the WPP core 141 would be performing ME for the block 427 and RDO for the block 426. Moreover, the WPP cores 141-144 may process the CTU rows with a lag of one CTU between two adjacent CTU rows. For example, at the pipeline cycle depicted in FIG. 4, the WPP core 141 is performing RDO for the block 425, whereas the WPP cores 142, 143 and 144 are performing RDO for the blocks 434, 443 and 452, respectively. Likewise, at the pipeline cycle depicted in FIG. 4, the WPP core 141 is performing ME for the block 426, whereas the WPP cores 142, 143 and 144 are performing ME for the blocks 435, 444 and 453, respectively.

In the description herein below, a notation {the top-left corner block, the bottom-right corner block} is used to refer to a rectangular area encompassing multiple blocks. In some embodiments, the inter-prediction module may perform the ME and RDO operations with a search range (SR) of five blocks by 5 blocks around the current block. For example, at the pipeline cycle depicted in FIG. 4, the WPP core 141 is performing RDO for the block 425 by accessing pixel data within a SR comprising the blocks 403-407, 413-417, 423-427, 433-437 and 443-447, namely, the SR of {block 403, block 447}. Meanwhile, the WPP core 141 is performing ME for the block 426 by accessing pixel data in a SR of {block 404, block 448}. At the same time, the processor 182 is loading blocks 409, 419, 429, 439 and 449 from the reference picture buffer 150 to the search memory 184, so that the blocks 409, 419, 429, 439 and 449 will be available for the WPP core 141 to perform ME for the block 427 at the next pipeline cycle.

As shown in FIG. 4, each of the SRAM banks 491, 492, 493 and 494 is required to store pixel data of 35 CTUs. Specifically, at the pipeline cycle depicted in FIG. 4, pixel data within {block 403, block 449} is stored in the bank 491, pixel data within {block 412, block 458} is stored in the bank 492, pixel data within {block 421, block 467} is stored in the bank 493, and pixel data within {block 430, block 476} is stored in the bank 494. That is, the search memory 184 is required to have a size of at least 35×4=140 CTUs.

Moreover, at the pipeline cycle depicted in FIG. 4, the bank 491 is pre-loading pixel data of {block 409, block 449}, the bank 492 is pre-loading pixel data of {block 418, block 458}, the bank 493 is pre-loading pixel data of {block 427, block 467}, the bank 494 is pre-loading pixel data of {block 436, block 476}. Namely, the search memory 184 is required to have a pre-loading bandwidth of 5×4=20 CTUs.

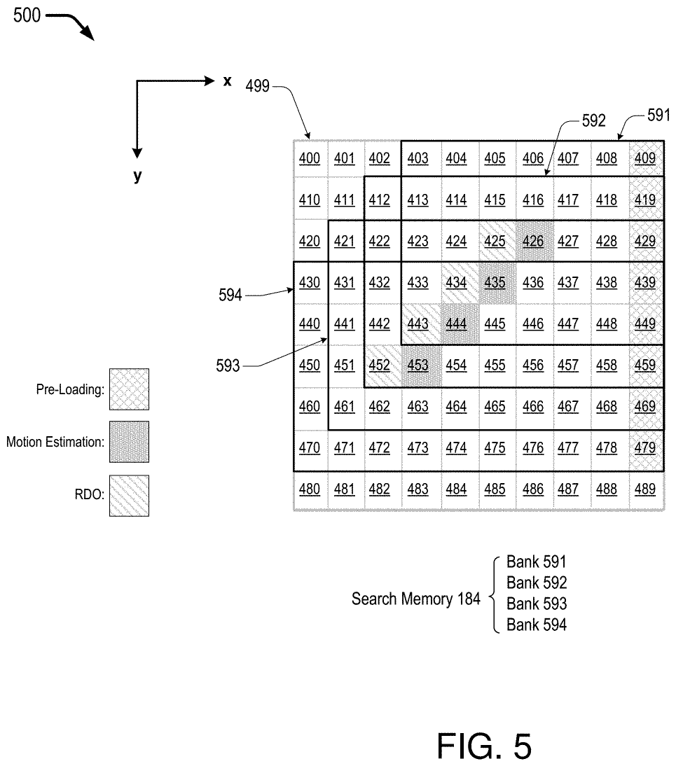

FIG. 5 is a diagram of an example design in accordance with an implementation of the present disclosure, wherein a search memory management scheme 500 is illustrated. In the search memory management scheme 500, the search memory 184 has four SRAM banks 591-594. The search memory management scheme 500 is able to reduce the pre-loading bandwidth of the search memory 184 as compared to that of FIG. 4. Unlike the banks 491-494, each of which has a same size of 35 CTUs, the bank 591-594 have non-uniform bank sizes. Specifically, pixel data within {block 403, block 449} is stored in the bank 591, pixel data within {block 412, block 459} is stored in the bank 592, pixel data within {block 421, block 469} is stored in the bank 593, and pixel data within {block 430, block 479} is stored in the bank 594. While the bank 591 has a same size of 35 CTUs as the bank 491, the bank 592 has a larger size than the bank 492 and is capable of storing 8×5=40 CTUs. The bank 593 is capable of storing 9×5=45 CTUs, whereas the bank 594 is capable of storing 10×5=50 CTUs. Therefore, in the search memory management scheme 500, the search memory 184 is required to have a size of at least 35+40+45+50=170 CTUs, which is 30 more CTUs as compared to the search memory management scheme depicted in FIG. 4. Also, the non-uniform bank sizes make the indexing of the SRAM banks more complicated. Nevertheless, being required to pre-load only {block 409, block 479}, the search memory 184 implementing the search memory management scheme 500 only needs to have a pre-loading bandwidth of 8 CTUs, as opposed to the 20 CTUs required in FIG. 4, thereby greatly reducing the processing latency of the inter-prediction module 140.

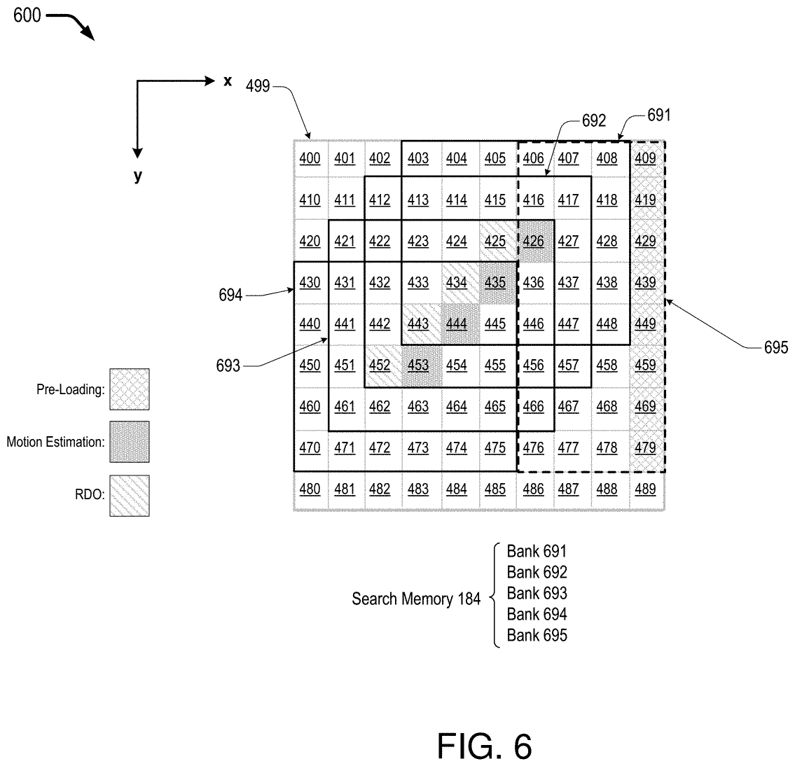

FIG. 6 is a diagram of an example design in accordance with an implementation of the present disclosure, wherein a search memory management scheme 600 is illustrated. In the search memory management scheme 600, the search memory 184 has SRAM banks 691-694, plus a fifth SRAM bank 695. The search memory management scheme 600 has the same pre-loading bandwidth as the search memory management scheme 500, which provides the same benefit of reducing the processing latency of the inter-prediction module 140. Meanwhile, unlike the non-uniform bank sizes of the SRAM banks 591-594, a uniform bank size is shared by the four SRAM banks 691-694, which makes the indexing of the SRAM banks less complicated as opposed to the search memory management scheme 500. Like the banks 491-494, each of which has a same size of 35 CTUs, the bank 691-694 also have a uniform bank size, but smaller, of 6×5=30 CTUs. Specifically, pixel data within {block 403, block 448} is stored in the bank 691, pixel data within {block 412, block 457} is stored in the bank 692, pixel data within {block 421, block 466} is stored in the bank 693, and pixel data within {block 430, block 475} is stored in the bank 594. The search memory 184 is required to pre-load {block 409, block 479}, which translates to a pre-loading bandwidth of 8 CTUs, same as that of the search memory management scheme 500. However, the search memory 184 is required to include the bank 695 as a pre-loading buffer for storing pixel data within {block 406, block 479}, a size of 32 CTUs in the search memory 184. The search memory 184 is therefore required to include at least the SRAM banks 691-695, a total size of 152 CTUs. This is more cost-effective as compared with the 170 CTUs required by the search memory management scheme 500.

Therefore, in the search memory management scheme 600, the search memory 184 is required to have a size of at least 30+30+30+30+32=152 CTUs, which is 12 more CTUs as compared to the search memory management scheme depicted in FIG. 4, but 18 fewer CTUs as compared to the search memory management scheme 500. Also, the uniform bank size makes the indexing of the SRAM banks easier. Same as in the case of the search memory management scheme 500, being required to pre-load only {block 409, block 479}, the search memory 184 implementing the search memory management scheme 600 only needs to have a pre-loading bandwidth of 8 CTUs, as opposed to the 20 CTUs required in FIG. 4, thereby greatly reducing the processing latency of the inter-prediction module 140.

When a parallel processing scheme like WPP is employed, it is important for the inter-prediction module 140 to access the proper type of motion vectors (MVs) from neighboring blocks as predictors for motion estimation. Referring to FIG. 4, the WPP core 142 may be performing ME for the block 435 and may require MVs from the neighboring block 425 as predictors. However, at the same pipeline cycle, the WPP core 141 is performing RDO for the block 425, and the MVs resulted from the RDO are still being updated. Accordingly, in performing ME for the block 435, the WPP core 142 may utilize MVs of the block 425 that have been generated by the WPP core 141 performing ME at the previous pipeline cycle, instead of MVs of the block 425 that are being generated or otherwise updated by the WPP core 141 performing RDO for the block 425 at the current pipeline cycle.

In some embodiments, when the WPP cores of the inter-prediction module 140 need to use MVs from neighboring blocks for performing ME for a current block, the WPP cores may universally use ME MVs (i.e., MVs resulted from ME) instead of RDO MVs (i.e., MVs resulted from RDO). In some alternative embodiments, the WPP cores may refrain from using MVs from neighboring blocks of the current frame, and use temporal MVs instead, i.e., MVs from neighboring blocks of other frames.

### IV. Illustrative Implementations

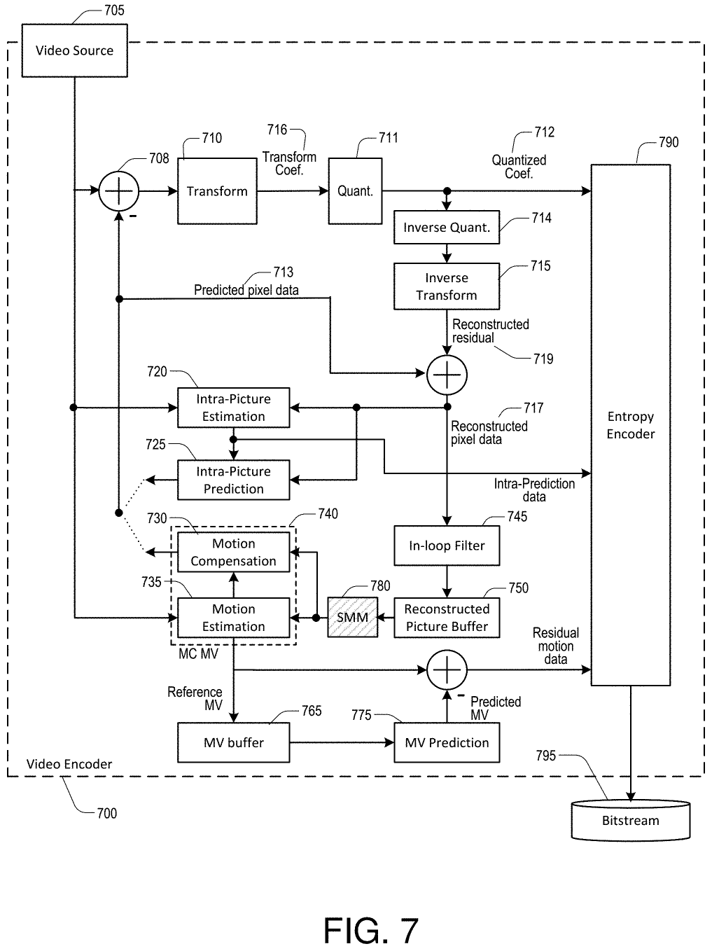

FIG. 7 illustrates an example video encoder 700, wherein the various embodiments, parallel processing schemes and memory management schemes described elsewhere herein above may be adopted. As illustrated, the video encoder 700 receives input video signal from a video source 705 and encodes the signal into bitstream 795. The video encoder 700 has several components or modules for encoding the signal from the video source 705, at least including some components selected from a transform module 710, a quantization module 711, an inverse quantization module 714, an inverse transform module 715, an intra-picture estimation module 720, an intra-prediction module 725, a motion compensation module 730, a motion estimation module 735, an in-loop filter 745, a reconstructed picture buffer 750, a motion vector (MV) buffer 765, a MV prediction module 775, a search memory management module (SMM) 780, and an entropy encoder 790. The motion compensation module 730 and the motion estimation module 735 are part of an inter-prediction module 740. The inter-prediction module 740 may include an integer motion estimation (IME) kernel which is configured to perform integer pixel search, as well as a fractional motion estimation (FME) kernel which is configured to perform fractional pixel search. Both the integer pixel search and the fractional pixel search are essential functions for the motion compensation module 730 and the motion estimation module 735.

In some embodiments, the modules 710-790 as listed above are modules of software instructions being executed by one or more processing units (e.g., a processor) of a computing device or electronic apparatus. In some embodiments, the modules 710-790 are modules of hardware circuits implemented by one or more integrated circuits (ICs) of an electronic apparatus. Though the modules 710-790 are illustrated as being separate modules, some of the modules can be combined into a single module.

The video source 705 provides a raw video signal that presents pixel data of each video frame without compression. That is, the video source 705 provides a video stream comprising pictures presented in a temporal sequence. A subtractor 708 computes the difference between the video data from the video source 705 and the predicted pixel data 713 from the motion compensation module 730 or intra-prediction module 725. The transform module 710 converts the difference (or the residual pixel data or residual signal 709) into transform coefficients (e.g., by performing Discrete Cosine Transform, or DCT). The quantization module 711 quantizes the transform coefficients into quantized data (or quantized coefficients) 712, which is encoded into the bitstream 795 by the entropy encoder 790.

The inverse quantization module 714 de-quantizes the quantized data (or quantized coefficients) 712 to obtain transform coefficients, and the inverse transform module 715 performs inverse transform on the transform coefficients to produce reconstructed residual 719. The reconstructed residual 719 is added with the predicted pixel data 713 to produce reconstructed pixel data 717. In some embodiments, the reconstructed pixel data 717 is temporarily stored in a line buffer (not illustrated) for intra-picture prediction and spatial MV prediction. The reconstructed pixels are filtered by the in-loop filter 745 and stored in the reconstructed picture buffer 750. In some embodiments, the reconstructed picture buffer 750 is a storage external to the video encoder 700. In some embodiments, the reconstructed picture buffer 750 is a storage internal to the video encoder 700.

The intra-picture estimation module 720 performs intra-prediction based on the reconstructed pixel data 717 to produce intra prediction data. The intra-prediction data is provided to the entropy encoder 790 to be encoded into bitstream 795. The intra-prediction data is also used by the intra-prediction module 725 to produce the predicted pixel data 713.

The motion estimation module 735 performs inter-prediction by producing MVs to reference pixel data of previously decoded frames stored in the reconstructed picture buffer 750. These MVs are provided to the motion compensation module 730 to produce predicted pixel data.

Instead of encoding the complete actual MVs in the bitstream, the video encoder 700 uses MV prediction to generate predicted MVs, and the difference between the MVs used for motion compensation and the predicted MVs is encoded as residual motion data and stored in the bitstream 795.

The MV prediction module 775 generates the predicted MVs based on reference MVs that were generated for encoding previously video frames, i.e., the motion compensation MVs that were used to perform motion compensation. The MV prediction module 775 retrieves reference MVs from previous video frames from the MV buffer 765. The video encoder 700 stores the MVs generated for the current video frame in the MV buffer 765 as reference MVs for generating predicted MVs.

The MV prediction module 775 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 795 by the entropy encoder 790.

The search memory management module (SMM) 780 determines a search range for one or more of the reference pictures of the current picture being encoded. The reference pictures are stored in the reconstructed picture buffer 750. The SMM 780 relays the pixel data within the search range to the inter-prediction module 740 for motion estimation and motion compensation. The SMM 780 may embody the SMM 180, at least the processor 182 and the search memory 184 thereof, as the ME module 186 may be embodied by the ME module 735 in a time-sharing manner. The reconstructed picture buffer 750 may embody the reference picture buffer 150. The inter-prediction module 740 may embody the inter-prediction module 140.

The entropy encoder 790 encodes various parameters and data into the bitstream 795 by using entropy-coding techniques such as context-adaptive binary arithmetic coding (CABAC) or Huffman encoding. The entropy encoder 790 encodes various header elements, flags, along with the quantized transform coefficients 712, and the residual motion data as syntax elements into the bitstream 795. The bitstream 795 is in turn stored in a storage device or transmitted to a decoder over a communications medium such as a network.

The in-loop filter 745 performs filtering or smoothing operations on the reconstructed pixel data 717 to reduce the artifacts of coding, particularly at boundaries of pixel blocks. In some embodiments, the filtering operation performed includes sample adaptive offset (SAO). In some embodiment, the filtering operations include adaptive loop filter (ALF).

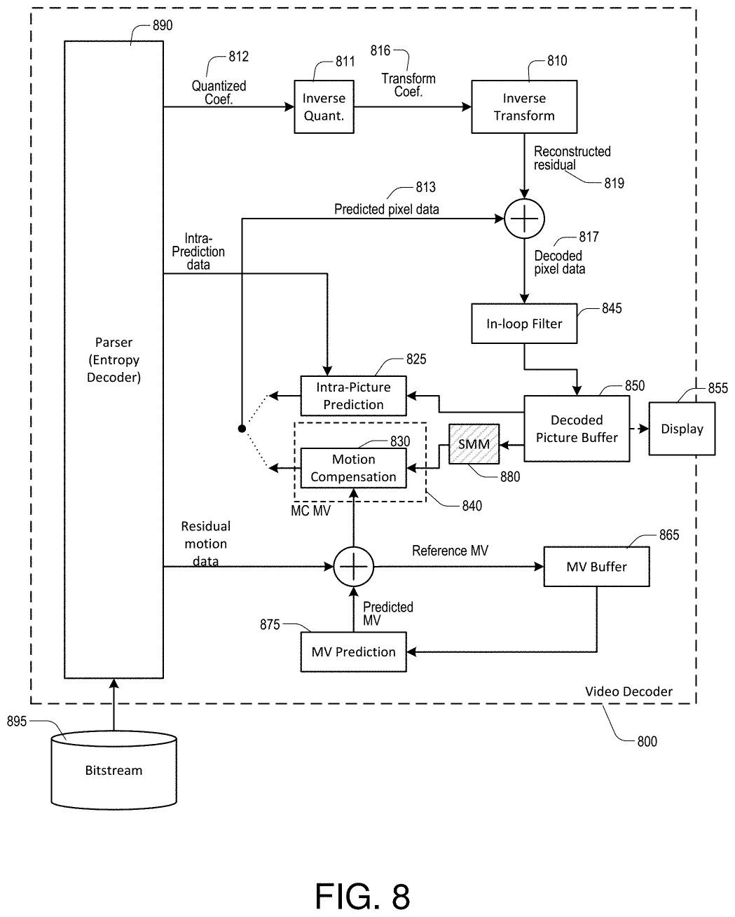

FIG. 8 illustrates an example video decoder 800. As illustrated, the video decoder 800 is an image-decoding or video-decoding circuit that receives a bitstream 895 and decodes the content of the bitstream 895 into pixel data of video frames for display. The video decoder 800 has several components or modules for decoding the bitstream 895, including some components selected from an inverse quantization module 811, an inverse transform module 810, an intra-prediction module 825, a motion compensation module 830, an in-loop filter 845, a decoded picture buffer 850, a MV buffer 865, a MV prediction module 875, search memory management module (SMM) 880, and a parser 890. The motion compensation module 830 is part of an inter-prediction module 840.

In some embodiments, the modules 810-890 are modules of software instructions being executed by one or more processing units (e.g., a processor) of a computing device. In some embodiments, the modules 810-890 are modules of hardware circuits implemented by one or more integrated circuits (ICs) of an electronic apparatus. Though the modules 810-890 are illustrated as being separate modules, some of the modules can be combined into a single module.

The parser (e.g., an entropy decoder) 890 receives the bitstream 895 and performs initial parsing according to the syntax defined by a video-coding or image-coding standard. The parsed syntax element includes various header elements, flags, as well as quantized data (or quantized coefficients) 812. The parser 890 parses out the various syntax elements by using entropy-coding techniques such as context-adaptive binary arithmetic coding (CABAC) or Huffman encoding.

The inverse quantization module 811 de-quantizes the quantized data (or quantized coefficients) 812 to obtain transform coefficients, and the inverse transform module 810 performs inverse transform on the transform coefficients 816 to produce reconstructed residual signal 819. The reconstructed residual signal 819 is added with predicted pixel data 813 from the intra-prediction module 825 or the motion compensation module 830 to produce decoded pixel data 817. The decoded pixels data are filtered by the in-loop filter 845 and stored in the decoded picture buffer 850. In some embodiments, the decoded picture buffer 850 is a storage external to the video decoder 800. In some embodiments, the decoded picture buffer 850 is a storage internal to the video decoder 800.

The intra-prediction module 825 receives intra-prediction data from bitstream 895 and according to which, produces the predicted pixel data 813 from the decoded pixel data 817 stored in the decoded picture buffer 850. In some embodiments, the decoded pixel data 817 is also stored in a line buffer (not illustrated) for intra-picture prediction and spatial MV prediction.

In some embodiments, the content of the decoded picture buffer 850 is used for display. A display device 855 either retrieves the content of the decoded picture buffer 850 for display directly or retrieves the content of the decoded picture buffer to a display buffer. In some embodiments, the display device receives pixel values from the decoded picture buffer 850 through a pixel transport.

The motion compensation module 830 produces predicted pixel data 813 from the decoded pixel data 817 stored in the decoded picture buffer 850 according to motion compensation MVs (MC MVs). These motion compensation MVs are decoded by adding the residual motion data received from the bitstream 895 with predicted MVs received from the MV prediction module 875.

The MV prediction module 875 generates the predicted MVs based on reference MVs that were generated for decoding previous video frames, e.g., the motion compensation MVs that were used to perform motion compensation. The MV prediction module 875 retrieves the reference MVs of previous video frames from the MV buffer 865. The video decoder 800 stores the motion compensation MVs generated for decoding the current video frame in the MV buffer 865 as reference MVs for producing predicted MVs.

The in-loop filter 845 performs filtering or smoothing operations on the decoded pixel data 817 to reduce the artifacts of coding, particularly at boundaries of pixel blocks. In some embodiments, the filtering operation performed includes sample adaptive offset (SAO). In some embodiment, the filtering operations include adaptive loop filter (ALF).

The search memory management module (SMM) 880 determines a search range for one or more of the reference pictures of the current picture being encoded. The reference pictures are stored in the decoded picture buffer 850. The SMM 880 relays the pixel data within the search range to the inter-prediction module 840 for motion estimation and motion compensation. The SMM 880 may embody the SMM 180. The decoded picture buffer 850 may embody the reference picture buffer 150. The inter-prediction module 840 may embody the inter-prediction module 140.

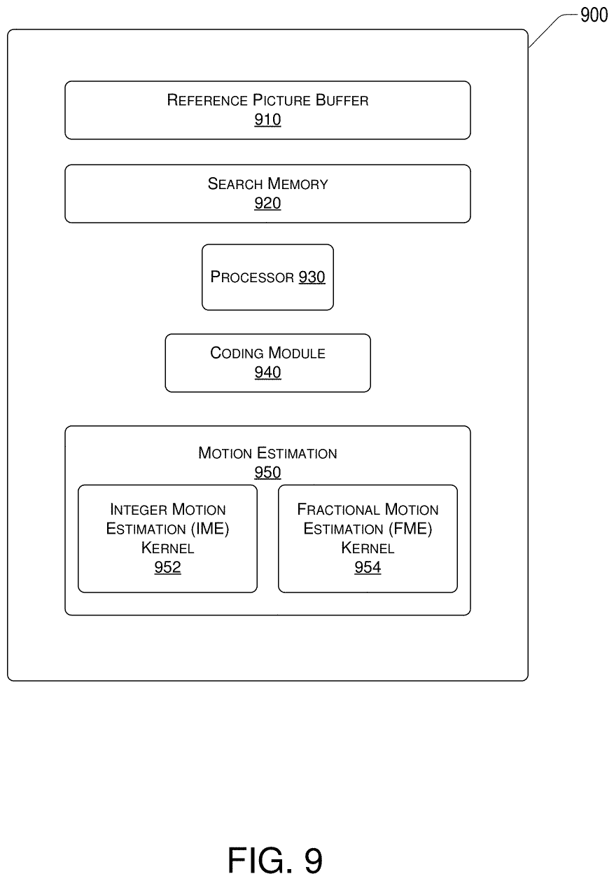

FIG. 9 illustrates a video coder 900 capable of encoding or decoding a video according to various search memory management schemes descried elsewhere herein above. The video coder 900 may process a current picture of the video using a block-based pipeline process for inter-picture prediction. The video coder 900 has several components or modules, including some components selected from a reference picture buffer (RPB) 910, a search memory 920, a processor 930, a coding module 940, and a motion estimation module 950. In some embodiments, the motion estimation module 950 may be a part of the coding module 940.

The RPB 910 may be configured to store a plurality of reference pictures of the current picture. For example, the video coder 900 may be processing the picture 103, and the RPB 910 may be configured to store the pictures 100, 102, 104 and 108, which are the reference pictures of the current picture 103. The RPB 910 may be configured to further store one or more reference picture lists (RPLs), such as the RPL 157 and/or the RPL 158. Each of the RPLs may be configured to store one or more indices corresponding to one or more of the plurality of reference pictures, respectively. In some embodiments, the indices may be the picture order count (POC) values of the reference pictures. The RPB 910 may be embodied by the reference picture buffer 150, the reconstructed picture buffer 750, or the decoded picture buffer 850.

The search memory 920 may be configured to store, for one or more of the reference pictures indicated in the RPL(s), pixel data within a search range of the respective reference picture. In some embodiments, the search memory 920 may be an SRAM accessible to the coding module 940. The search memory 920 may be embodied by the search memory 184 of the search memory management module 180.

The processor 930 may be embodied by the processor 182 of the search memory management module 180. The processor 930 may be configured to determine a quantity of the of reference pictures of the current picture. The processor 930 may determine the quantity based on the one or more RPLs stored in the RPB 910. For example, the processor 930 may examine the RPL 157 and/or the RPL 158 and determine the quantity of the reference pictures of the current picture 103 as four. The processor 930 may also be configured to determine, for one or more of the reference pictures, a corresponding search range (SR) size based on the quantity. In some embodiments, the processor 930 may firstly determine a basic size based on the quantity, and then secondly determine the SR size for a reference picture based on the basic size. For example, the processor 930 may firstly determine the basic size 299, and subsequently determine the sizes of the SRs 209, 229, 249 and 289 based on the basic size 299 according to the adaptive SR size schemes described elsewhere herein above.

In addition to the size(s) of the SR(s), the processor 930 may also be configured to determine the location(s) of the SR(s). The processor 930 may determine the location of each of the SRs based on the location of the current block, i.e., the block that is being processed. In some embodiments, the center of the SRs is aligned with the center of the block, and thus the locations of the SRs are uniquely determined based on the location of the current block. In some alternative embodiments, there may exist a spatial displacement between the location of a SR and the location of the current block. The spatial displacement may be represented by a vector, such as the vector 201 or 281. In some embodiments, the processor 930 may designate a macro motion vector (MMV) as the spatial displacement, wherein the MMV represents a spatial displacement from the current picture to the respective reference picture. The video coder 900 may include the motion estimation (ME) module 950, which may be configured to determine the MMV. The ME module 950 may be embodied by the ME module 186 or the ME module 735. The ME module 950 may include an integer motion estimation (IME) kernel 952. In some embodiments, the ME module 950 may also include a fractional motion estimation (FME) kernel 954. The IME kernel 952 is configured to perform integer pixel search, whereas the FME kernel 954 is configured to perform fractional pixel search.

Moreover, the processor 930 may also be configured to store, to the search memory 920, pixel data within the SR of each reference picture. For example, the processor 930 may store pixel data within the SRs 209, 229, 249 and 289 to the search memory 920 so that the coding module 940 may subsequently access the search memory 920 and encode or decode the current picture 103 using the pixel data stored in the search memory 920.

### V. Illustrative Processes

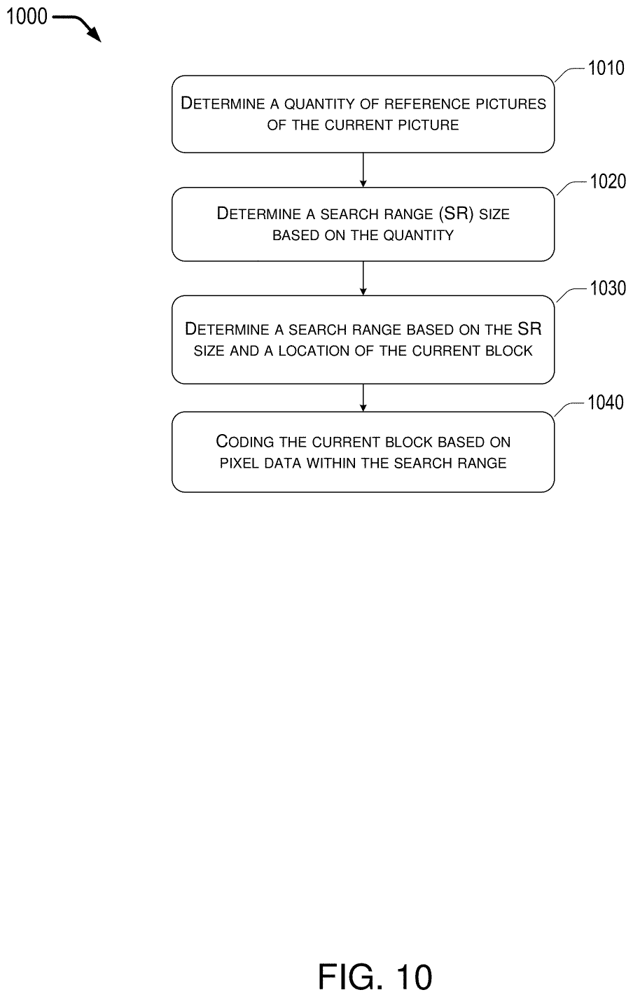

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to coding a current block of a current picture based on search memory management schemes involving adaptive search ranges in accordance with the present disclosure. Process 1000 may include one or more operations, actions, or functions as illustrated by one or more of blocks 1010, 1020, 1030 and 1040. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10, or alternatively in a different order. Furthermore, one or more of the blocks/sub-blocks of process 1000 may be executed repeatedly or iteratively. Process 1000 may be implemented by or in the apparatus 900 as well as any variations thereof. Solely for illustrative purposes and without limiting the scope, process 1000 are described below in the context of the apparatus 900. Process 1000 may begin at block 1010.

At 1010, process 1000 may involve the processor 930 determining a quantity of a plurality of reference pictures of the current picture. For example, the processor 930 may examine one or more reference picture lists (RPLs) stored in the reference picture buffer (RPB) 910, wherein each of the RPLs may include one or more indices, such as POC values, that correspond to the plurality of reference pictures. Process 1000 may proceed from 1010 to 1020.

At 1020, process 1000 may involve the processor 930 determining, for at least one of the plurality of reference pictures, a corresponding search range (SR) size based on the quantity. For example, the processor 930 may determine the SR size as listed in the table 310 or 320 based on the quantity as listed therein. In some embodiments, the processor 930 may determine a basic size based on the quantity, and then determine the SR size based on the basic size, as illustrated in the tables 310 and 320. Process 1000 may proceed from 1020 to 1030.

At 1030, process 1000 may involve the processor 930 determining, for the at least one of the plurality of reference pictures, a respective SR of the respective reference picture based on the SR size determined at 1020 as well as a location of the current block. For example, the processor 930 may determine a location of the SR to be uniquely determined by the location of the current block. By determining the location of the SR and the size of the SR, the processor 930 determines the SR. For instance, the processor 930 may determine a SR, such as one of the SRs 209, 229, 249 and 289, based on the SR size as listed in the table 310 or 320, as well as the location of the current block 217. In some embodiments, the location of the SR is not solely determined based on the location of the current block. For example, the motion estimation module 950 may perform motion estimation with the current picture and the reference picture as input, thereby determining a macro motion vector (MMV) that represents a spatial displacement between the current picture and the reference picture (e.g., the vector 201 or 281), and then determine the location of the SR based on the location of the current block and the spatial displacement. Process 1000 may proceed from 1030 to 1040.

At 1040, process 1000 may involve the coding module 940 coding the current block based on pixel data within the SR of the at least one of the plurality of reference pictures. For example, the coding module 940 may encode or decode the current block 217 based on pixel data within the SRs 209, 229, 249 and 289. Specifically, the coding module 940 may firstly determine the best-matching blocks 203, 223, 243 and 283 respectively based on the pixel data within the SRs 209, 229, 249 and 289. The coding module 940 may subsequently encode the current block 217 based on the best-matching blocks 203, 223, 243 and 283.

### VI. Illustrative Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

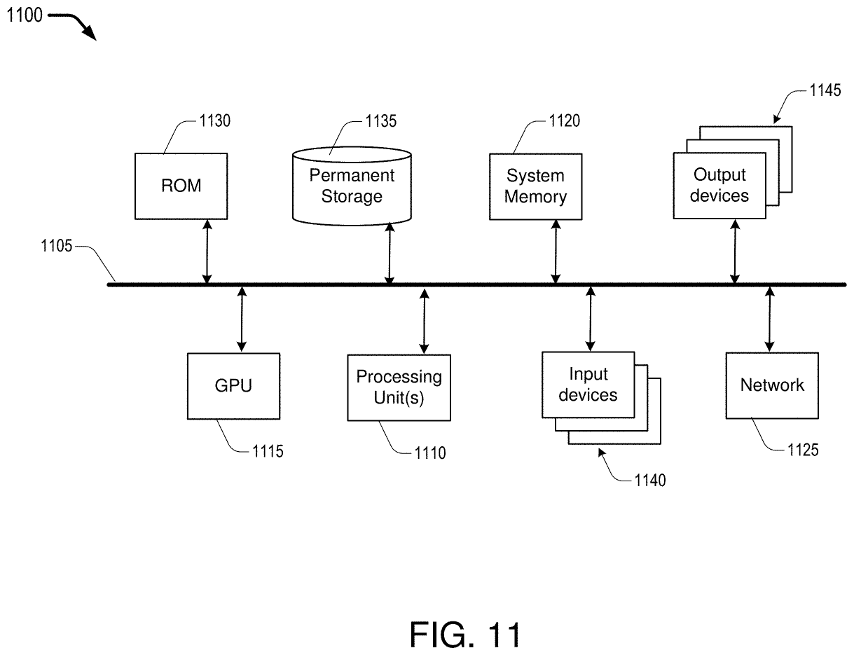

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1100 includes a bus 1105, processing unit(s) 1110, a graphics-processing unit (GPU) 1115, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 retrieves instructions to execute and data to process in order to execute the processes of the present disclosure. The processing unit(s) may be a single processor or a multi-core processor in different embodiments. Some instructions are passed to and executed by the GPU 1115. The GPU 1115 can offload various computations or complement the image processing provided by the processing unit(s) 1110.

The read-only-memory (ROM) 1130 stores static data and instructions that are used by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor uses at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals. While the present disclosure has been described with reference to numerous specific details, one of ordinary skill in the art will recognize that the present disclosure can be embodied in other specific forms without departing from the spirit of the present disclosure.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method of processing a current block of a current picture, comprising:
determining a quantity of a plurality of reference pictures of the current picture;
determining, for at least one of the plurality of reference pictures, a search range (SR) size based on the quantity;
determining, for the at least one of the plurality of reference pictures, a SR of the at least one of the plurality of reference pictures based on the SR size and a location of the current block; and
coding the current block based on pixel data within the SR.

2. The method of claim 1, wherein the determining of the quantity comprises examining one or more lists each comprising one or more indices, each of the one or more indices corresponding to one of the plurality of reference pictures.

3. The method of claim 2, wherein the one or more lists comprises a first list comprising a first number of indices and a second list comprising a second number of indices, wherein the determining of the quantity further comprises calculating a sum of the first number and the second number, and wherein the determining of the corresponding SR size based on the quantity comprises:
determining a basic size based on the sum;
designating the basic size as the SR size responsive to the respective reference picture being in only one of the first and second lists; and
designating a double of the basic size as the SR size responsive to the respective reference picture being in both the first and second lists.

4. The method of claim 3, wherein the determining of the basic size is further based on a size of a search memory configured to store the pixel data within the SR.

5. The method of claim 1, wherein the at least one of the plurality of reference pictures comprises two or more of the plurality of reference pictures, and wherein the determining of the corresponding SR size comprises:
determining a basic size based on the quantity of the plurality of reference pictures;
determining, for each of the two or more of the plurality of reference pictures, a corresponding temporal distance with respect to the current picture;
designating a first size smaller than the basic size as the SR size for a first reference picture of the two or more of the plurality of reference pictures; and
designating a second size larger than the basic size as the SR size for a second reference picture of the two or more of the plurality of reference pictures, wherein the temporal distance corresponding to second reference picture is larger than the temporal distance corresponding to first reference picture.

6. The method of claim 5, wherein the determining of the temporal distance with respect to the current picture comprises calculating an absolute value of a difference between a picture order count (POC) of the respective reference picture and a POC of the current picture.

7. The method of claim 1, wherein the at least one of the plurality of reference pictures comprises two or more of the plurality of reference pictures, and wherein the determining of the SR size for each of the two or more of the plurality of reference pictures comprises:
determining a basic size based on the quantity of the plurality of reference pictures;
determining, for each of the two or more of the plurality of reference pictures, a corresponding spatial distance with respect to the current picture;
designating a first size smaller than the basic size as the SR size for a first reference picture of the two or more of the plurality of reference pictures; and
designating a second size larger than the basic size as the SR size for a second reference picture of the two or more of the plurality of reference pictures, wherein the spatial distance corresponding to the second reference picture is larger than the spatial distance corresponding to the first reference picture.

8. The method of claim 7, wherein the determining of the spatial distance with respect to the current picture comprises performing motion estimation based on one or more blocks of the current picture and one or more blocks of the respective reference picture that correspond to the one or more blocks of the current picture.

9. The method of claim 1, wherein the at least one of the plurality of reference pictures comprises two or more of the plurality of reference pictures, and wherein the determining of the SR size for each of the two or more of the plurality of reference pictures comprises:
determining a basic size based on the quantity of the plurality of reference pictures;
designating a first size smaller than the basic size as the SR size for a first reference picture of the two or more of the plurality of reference pictures, the first reference picture having a theme change as compared to the current picture; and
designating a second size larger than the basic size as the SR size for a second reference picture of the two or more of the plurality of reference pictures, the second reference picture not having a theme change as compared to the current picture.

10. The method of claim 9, wherein the first size is zero.

11. An apparatus, comprising:
a reference picture buffer (RPB) configured to store a plurality of reference pictures of a current picture and one or more reference picture lists (RPLs) each configured to store one or more indices, each of the one or more indices corresponding to one of the plurality of reference pictures;
a search memory;
a processor configured to perform operations comprising:
determining a quantity of the plurality of reference pictures based on the one or more RPLs;
determining, for at least one of the plurality of reference pictures, a search range (SR) size based on the quantity;
determining a SR of the at least one of the plurality of reference pictures based on the SR size and a location of the current block; and
storing the pixel data within the SR to the search memory; and
a coding module configured to code the current block using the pixel data stored in the search memory.

12. The apparatus of claim 11, further comprising:
a motion estimation module configured to determine, for the at least one of the plurality of reference pictures, a macro motion vector (MMV) representing a spatial displacement from the current picture to the at least one of the plurality of reference pictures,
wherein the determining of the SR is further based on the MMV.

13. The apparatus of claim 11, wherein the one or more RPLs comprises a first list comprising a first number of indices and a second list comprising a second number of indices, and wherein the determining of the SR size based on the quantity comprises:
determining a basic size based on a sum of the first number and the second number;
designating the basic size as the SR size responsive to the at least one of the plurality of reference pictures being in only one of the first and second lists; and
designating a double of the basic size as the SR size responsive to the at least one of the plurality of respective reference pictures being in both the first and second lists.

14. The apparatus of claim 13, wherein the determining of the basic size is further based on a size of the search memory.

15. The apparatus of claim 11, wherein the at least one of the plurality of reference pictures comprises two or more of the plurality of reference pictures, and wherein the determining of the SR size based on the quantity comprises:
determining a basic size based on the quantity;
determining, for each of the two or more of the plurality of reference pictures, a corresponding temporal distance with respect to the current picture;
designating a first size smaller than the basic size as the SR size for a first reference picture of the two or more of the plurality of reference pictures; and
designating a second size larger than the basic size as the SR size for a second reference picture of the two or more of the plurality of reference pictures, wherein the temporal distance corresponding to second reference picture is larger than the temporal distance corresponding to first reference picture.

16. The apparatus of claim 15, wherein the determining of the temporal distance with respect to the current picture comprises calculating an absolute value of a difference between a picture order count (POC) of the respective reference picture and a POC of the current picture.

17. The apparatus of claim 11, further comprising:
a motion estimation module,
wherein the at least one of the plurality of reference pictures comprises two or more of the plurality of reference pictures,
wherein the motion estimation module is configured to determine, for each of the two or more of the plurality of reference pictures, a respective macro motion vector (MMV) representing a spatial displacement from the current picture to the respective reference picture, and
wherein the motion estimation module determines the respective MMV based on one or more blocks of the current picture and corresponding one or more blocks of the respective reference picture.

18. The apparatus of claim 17, wherein the determining of the SR size for each of the two or more of the plurality of reference pictures comprises:
determining a basic size based on the quantity of the plurality of reference pictures;
designating a first size smaller than the basic size as the SR size for a first reference picture of the two or more of plurality of reference pictures; and
designating a second size larger than the basic size as the SR size for a second reference picture of the two or more of the plurality of reference pictures, wherein a magnitude of the MMV corresponding to the second reference picture is larger than a magnitude of the MMV corresponding to the first reference picture.

19. The apparatus of claim 11, wherein the at least one of the plurality of reference pictures comprises two or more of the plurality of reference pictures, and wherein the determining of the SR size for each of the two or more of the plurality of reference pictures comprises:
determining a basic size based on the quantity of the plurality of reference pictures;
designating a first size smaller than the basic size as the SR size for a first reference picture of the two or more of the plurality of reference pictures, the first reference picture having a theme change as compared to the current picture; and
designating a second size larger than the basic size as the SR size for a second reference picture of the two or more of the plurality of reference pictures, the second reference picture not having a theme change as compared to the current picture.

20. The apparatus of claim 19, wherein the first size is zero.
